(19) United States
(12) Patent Application Publication
(10) Pub. No.: US 2022/0276513 A1
(43) Pub. Date: Sep. 1, 2022

(54) OPTICAL MODULATION ELEMENT AND OPTICAL MODULATOR

(71) Applicant: TDK Corporation, Tokyo (JP)

(72) Inventors: Hajime UTSUNOMIYA, Tokyo (JP); Takashi KIKUKAWA, Tokyo (JP)

(73) Assignee: TDK Corporation, Tokyo (JP)

(21) Appl. No.: 17/678,096

(22) Filed: Feb. 23, 2022

(30) Foreign Application Priority Data
Feb. 26, 2021 (JP) 2021-031191

(51) Int. Cl. G02F 1/035; G02F 1/21; G02F 1/03; G02F 1/225

(52) U.S. Cl. CPC G02F 1/035; G02F 1/212; G02F 1/0316; G02F 1/225; G02F 2202/20

(57) ABSTRACT

A optical modulation element includes a substrate made of a material different from lithium niobate, a lithium niobate film formed on a main surface of the substrate, the lithium niobate film including a Mach-Zehnder-type optical waveguide having a first ridge and a second ridge that function as a first optical waveguide and a second optical waveguide, respectively, wherein both the first ridge and the second ridge having a cross-sectional shape fixed portion, at least one of the first ridge and the second ridge having a cross-sectional shape non-fixed portion in which the cross-sectional shape is different from that of the cross-sectional shape fixed portion, and the optical output obtained when the DC bias voltage applied between the first electrode and the second electrode is 0 (V) is smaller than the maximum of the optical output obtained when the DC bias voltage is changed in a predetermined voltage range.

### TECHNICAL FIELD

The present disclosure relates to an optical modulation element and an optical modulator.

Priority is claimed on Japanese Patent Application No. 2021-31191, filed Feb. 26, 2021, the content of which is incorporated herein by reference.

### BACKGROUND ART

Communication traffic has been remarkably increased with widespread Internet use, and optical fiber communication is increasingly significant. The optical fiber communication is a technology that converts an electric signal into an optical signal and transmits the optical signal through an optical fiber and has a wide bandwidth, a low loss, and a resistance to noise.

The optical modulator converts an electrical signal into an optical signal. For example, Patent Literatures 1 and 2 describe a Mach-Zehnder type optical modulator in which an optical waveguide is formed by Ti (titanium) diffusion near the surface of a lithium niobate single crystal substrate. Further, Patent Literature 2 describes to correct the operating point drift of the optical modulator. The optical modulators described in Patent Literatures 1 and 2 operate at a high speed of 40 Gb/s or more, but have a long total length of about 10 cm.

On the other hand, Patent Literature 3 describes a Mach-Zehnder type optical modulator using a c-axis oriented lithium niobate film. The optical modulator using the lithium niobate film is smaller and has a lower drive voltage than the optical modulator using the lithium niobate single crystal substrate.

### CITATION LIST

### Patent Literature

[Patent Literature 1] Japanese Unexamined Patent Application, First Publication No. 2004-37695
[Patent Literature 2] Japanese Patent Publication No. 4164179
[Patent Literature 3] Japanese Unexamined Patent Application, First Publication No. 2019-45880
[Patent Literature 4] Japanese Patent Publication No. 2817295
[Patent Literature 5] Japanese Unexamined Patent Application, First Publication No. H05-297332
[Patent Literature 6] Japanese Unexamined Patent Application, First Publication No. H05-297333
[Patent Literature 7] Japanese Unexamined Patent Application, First Publication No. 2008-52103

### SUMMARY OF THE INVENTION

### Technical Problem

Optical modulators using lithium niobate have a large extinction ratio and can operate in a high frequency band, and are therefore used for long-distance communication such as between cities. Further, since an optical modulator using indium phosphide can operate in a high frequency band, it is expected to be used for long-distance communication. On the other hand, in recent years, short- and medium-distance communications such as within and between data centers are increasing, and in such applications, it is required to reduce the size of the optical modulator. As a phase modulator becomes shorter with the miniaturization of the optical modulator, the voltage for π-shifting the phase (half-wavelength voltage) increases, and the DC bias voltage applied to adjust the operating point voltage increases.

It is disclosed that by making the lengths of the two optical waveguides constituting the phase modulator asymmetric, a phase difference is generated between the two optical waveguides when no DC bias voltage is applied, and then the operating point voltage is shifted in this state (see, Patent Literatures 4-6). Patent Literature 4 discloses an optical modulator in which one of two optical waveguides is curved so that the length is different from the other one in order to shift the operating point voltage. In the Literature, the positions of the branching section and the coupling section are separated from the center lines of the two optical waveguides to shift the operating point voltage, and the angle changes (opening angles) before and after the branch are made uniform for the two optical waveguides. Patent Literatures 5 and 6 disclose an optical modulator in which the lengths of two optical waveguides are made asymmetrical for the same purpose as in Patent Literature 4, and the distance between the waveguides is kept constant. In the methods disclosed in Patent Literatures 4 to 6, the shape of the optical waveguide is complicated, design restrictions are increased, and further miniaturization is difficult.

Patent Literature 7 discloses that at least a part of one optical waveguide have different widths from the other optical waveguide facing each other, but this is based on the Ti diffusion waveguide. In Patent Literature 7, the reason why the widths of the two facing parts of the optical waveguide are different is to suppress the coupling of the propagating light when the optical waveguides are close to each other, and there is no description about the operating point control.

The present disclosure has been made in view of the above circumstances, it is an object of the present invention to provide an optical modulation element that can be easily manufactured while suppressing the applied DC bias voltage to a low level even when the element size is small, and an optical modulator equipped with it.

### Solution to Problem

The present disclosure provides the following means to resolve the above problems.

According to a first aspect of the present disclosure, there is provided an optical modulation element, including a substrate made of a material different from lithium niobate; a lithium niobate film formed on a main surface of the substrate, the lithium niobate film including a Mach-Zehnder-type optical waveguide having a first ridge and a second ridge that function as a first optical waveguide and a second optical waveguide connected a branching section and a coupling section, respectively, wherein both the first ridge and the second ridge having a cross-sectional shape fixed portion in which the cross-sectional shapes orthogonal to the length direction are the same, at least one of the first ridge and the second ridge having a cross-sectional shape non-fixed portion in which the cross-sectional shape is different from that of the cross-sectional shape fixed portion, and the optical output obtained when the DC bias voltage applied between the first electrode and the second electrode is 0 (V) is smaller than the maximum of the optical output obtained when the DC bias voltage is changed in a predetermined voltage range.

In the optical modulation element according to the first aspect, the width of the cross-sectional shape non-fixed portion may be different from that of the cross-sectional shape non-fixed portion.

In the optical modulation element according to the first aspect, the cross-sectional area of the cross-sectional shape non-fixed portion may be different from that of the cross-sectional shape non-fixed portion.

In the optical modulation element according to the first aspect, the cross-sectional shape non-fixed portion may be arranged in a region that does not overlap with either the first electrode or the second electrode.

In the optical modulation element according to the first aspect, the optical output obtained when the DC bias voltage may be 0 (V) is 85% or less of the difference between the maximum and minimum values of the optical output obtained when the DC bias voltage is changed in a predetermined voltage range.

According to a second aspect of the present disclosure, there is provided an optical modulator including the optical modulation element according to the first aspect.

### Advantageous Effects of Invention

According to the present invention, it is possible to provide an optical modulation element capable of suppressing the applied DC bias voltage to a low level and being easily manufactured, and an optical modulator provided with the optical modulation element.

### BRIEF DESCRIPTION OF THE DRAWINGS

FIG. 1 is a block diagram of an optical modulator according to one embodiment.

FIG. 2 is a top view of an optical modulation element according to one embodiment.

FIG. 3 is a top view of an optical waveguide according to one embodiment.

FIG. 4 is a cross-sectional schematic diagram of an optical modulation element according to one embodiment.

FIG. 5 is a cross-sectional schematic diagram of an optical modulation element according to one embodiment.

FIG. 6 is a diagram which shows the relationship between the applied voltage and the output of the optical modulator according to one embodiment.

FIG. 7A is a diagram for demonstrating the optical modulation of an example of the optical modulator according to one embodiment.

FIG. 7B is a diagram for demonstrating the optical modulation of the other example of the optical modulator according to one embodiment.

FIG. 7C is a diagram for demonstrating the optical modulation of the other example of the optical modulator according to one embodiment.

FIG. 8A is a diagram which shows the relationship between the applied voltage of the optical modulator shown in FIG. 7A and the extinction ratio.

FIG. 8B is a diagram which shows the relationship between the applied voltage of the optical modulator shown in FIG. 7B and the extinction ratio.

FIG. 8C is a diagram which shows the relationship between the applied voltage of the optical modulator shown in FIG. 7C and the extinction ratio.

FIG. 9 is a graph which shows the optical output characteristics of the optical modulator according to Examples and Comparative Example.

### DESCRIPTION OF EMBODIMENTS

Hereinafter, the present invention will be described in detail with reference to the drawings as appropriate. The drawings used in the following description may be enlarged for convenience in order to make the features of the present invention easy to understand, and the dimensional ratios of each component may differ from the actual ones. The materials, dimensions, and the like exemplified in the following description are examples, and the present invention is not limited thereto, and can be appropriately modified and carried out within the range in which the effects of the present invention are exhibited.

First, the directions are defined. One direction of one surface of the substrate (the base) Sb is the x direction, and a direction orthogonal to the x direction is the y direction. The x direction is, for example, the direction in which the first optical waveguide 11 extends. The z direction is a direction perpendicular to one surface of the substrate Sb. The z direction is a direction orthogonal to the x direction and the y direction. Hereinafter, the +z direction may be expressed as “up” and the −z direction may be expressed as “down”. The “up” and “down” do not always match the direction in which gravity is applied.

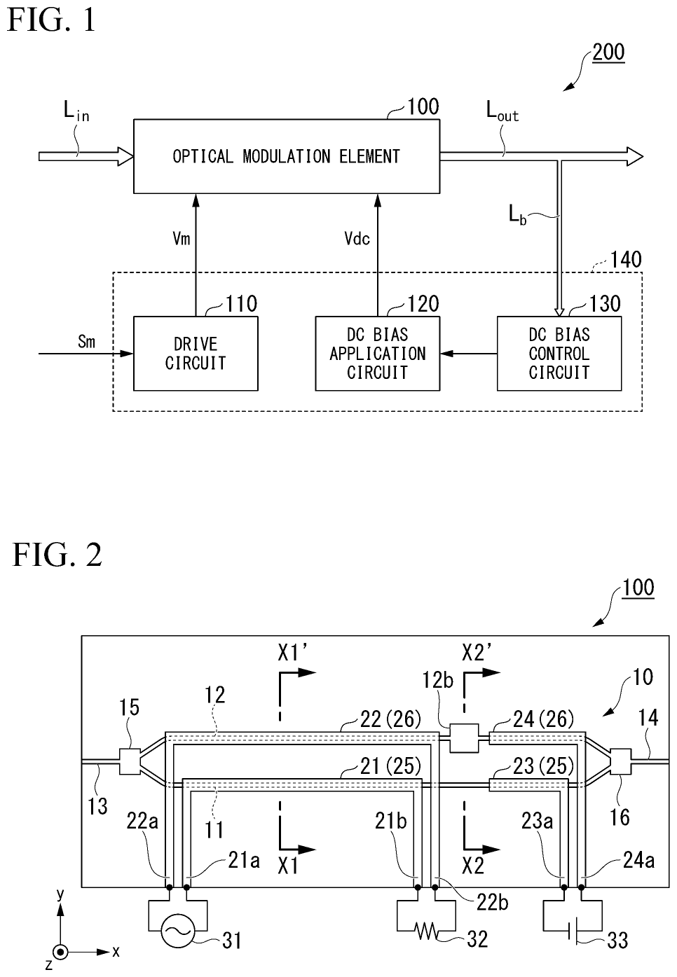

FIG. 1 is a block diagram of the optical modulator 200 according to the first embodiment. The optical modulator 200 includes an optical modulation element 100, a drive circuit 110, a DC bias application circuit 120, and a DC bias control circuit 130. The control unit 140 of the optical modulator 200 includes a drive circuit 110, a DC bias application circuit 120, and a DC bias control circuit 130.

The optical modulation element 100 converts an electric signal into an optical signal. The optical modulation element 100 converts the input light Lᵢₙ into the output light Lₒᵤₜ according to the modulation signal Sm.

The drive circuit 110 applies a modulation voltage Vm corresponding to the modulation signal Sm to the optical modulation element 100. The DC bias application circuit 120 applies a DC bias voltage Vdc to the optical modulation element 100. The DC bias control circuit 130 monitors the output light Lₒᵤₜ and controls the DC bias voltage Vdc output from the DC bias application circuit 120. By adjusting this DC bias voltage Vdc, the operating point Vd described later is controlled.

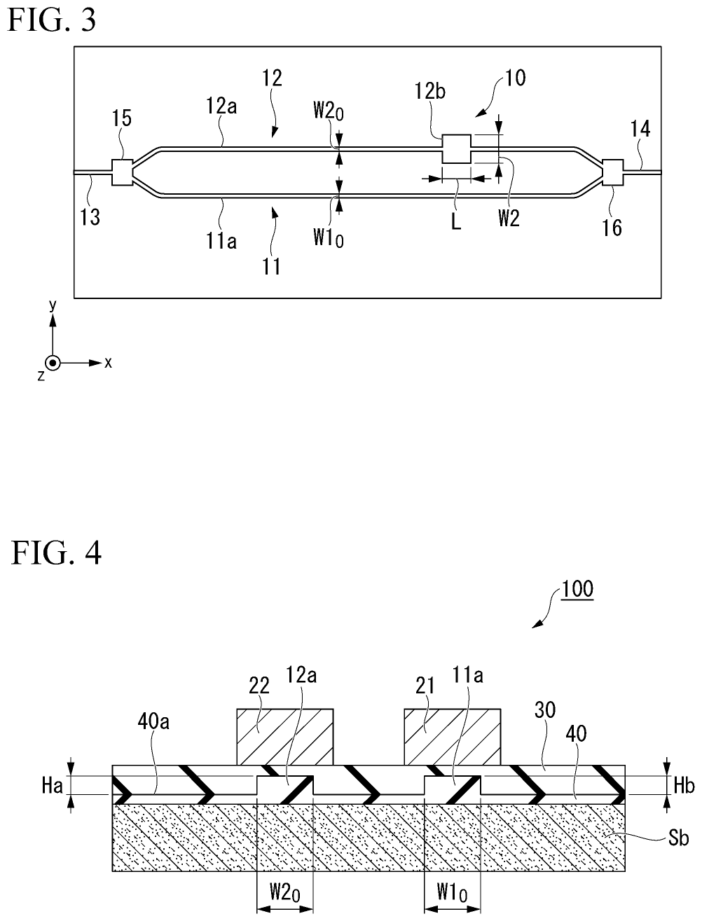

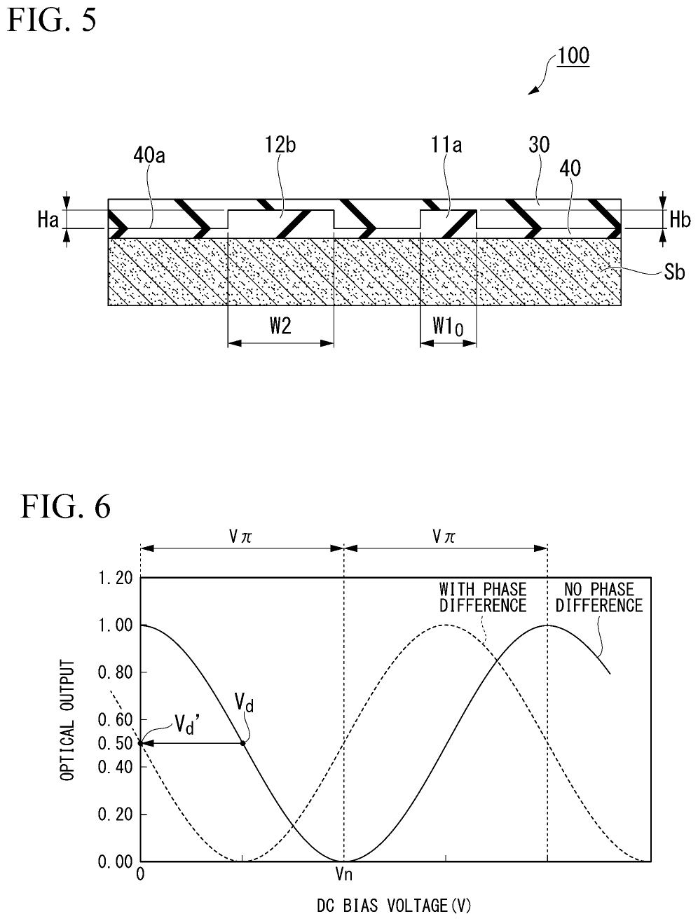

FIG. 2 is a plan view of the optical modulation element 100 as viewed from the z direction. FIG. 3 is a plan view of the optical waveguide 10 of the optical modulation element 100 as viewed from the z direction. FIG. 4 is a cross section cut along X1-X1′ in FIG. 2. FIG. 5 is a cross section cut along X2-X2′ in FIG. 2.

The optical modulation element 100 includes a substrate Sb made of a material different from that of lithium niobate, and a lithium niobate film (oxide film) 40 formed on one main surface of the substrate Sb. The lithium niobate film 40 has a first ridge 11 and a second ridge 12 projecting to the opposite side of the substrate Sb. The first ridge 11 and the second ridge 12 form a Mach-Zehnder type optical waveguide 10, and function as a first optical waveguide and a second optical waveguide connected the branching section 15 and the coupling section 16, respectively. Hereinafter, the first optical waveguide may be referred to as the first optical waveguide 11 using the reference numeral 11, and similarly, the second optical waveguide may be referred to as the second optical waveguide 12 using the reference numeral 12. The optical modulation element 100 further includes a first electrode 25 that applies an electric field to the first optical waveguide 11, and a second electrode 26 that applies an electric field to the second optical waveguide 12.

The first electrode 25 and the second electrode 26 are connected to at least an AC power supply 31 (drive circuit 110) that applies a modulation voltage between both electrodes and a DC power supply 33 (DC bias application 120) that applies a DC bias voltage between the two electrodes. Here, the case where the first electrode 25 is divided into an AC first electrode 21 for connecting the AC power supply 31 and a DC first electrode 23 for connecting the DC power supply 33, and the second electrode 26 is divided into an AC second electrode 22 for connecting the AC power supply 31 and a DC second electrode 24 for connecting the DC power supply 33 is illustrated. The AC first electrode 21 and the DC first electrode 23 may be integrated or separated as separate bodies. Further, the AC second electrode 22 and the DC second electrode 24 may be integrated or separated as separate bodies. Hereinafter, the AC first electrode 21, the AC second electrode 22, the DC first electrode 23, and the DC second electrode 24 may be referred to as an electrode 21, an electrode 22, an electrode 23, and an electrode 24, respectively.

The optical modulation element 100 includes a substrate Sb. The substrate Sb may be any substrate on which an oxide film 40 such as a lithium niobate film (LN film) can be formed as an epitaxial film, and a sapphire single crystal substrate or a silicon single crystal substrate is preferable. The crystal orientation of the substrate Sb is not particularly limited. The lithium niobate film has a property of being easily formed as a c-axis oriented epitaxial film with respect to the substrate Sb having various crystal orientations. Since the crystal constituting the c-axis oriented lithium niobate film has symmetry of three times symmetry, it is desirable that the underlying substrate Sb also has the same symmetry, and in the case of a silicon single crystal substrate, a (111)-plane substrate is preferable.

The optical waveguide 10 is a light passage through which light propagates inside. The optical waveguide 10 has, for example, a first optical waveguide 11, a second optical waveguide 12, an input path 13, an output path 14, a branching section 15, and a coupling section 16. The first optical waveguide 11 and the second optical waveguide 12 shown in FIG. 3 have a configuration extending in the x direction except for the vicinity of the branching section 15 and the vicinity of the coupling section 16, but are not limited to such a configuration. The lengths of the first optical waveguide 11 and the second optical waveguide 12 shown in FIG. 3 are substantially the same. The branching section 15 is located between the input path 13, and the first optical waveguide 11 and the second optical waveguide 12. The input path 13 is connected to the first optical waveguide 11 and the second optical waveguide 12 via the branching section 15. The coupling section 16 is located between the first optical waveguide 11, and the second optical waveguide 12 and the output path 14. The first optical waveguide 11 and the second optical waveguide 12 are connected to the output path 14 via the coupling section 16.

The optical waveguide 10 includes a first optical waveguide 11 and a second optical waveguide 12 which are ridges protruding from the first surface 40a of the lithium niobate film 40. The first surface 40a is the upper surface of the lithium niobate film 40 in a portion other than the ridges. The two ridges (the first ridge portion and the second ridge portion) project from the first surface 40a in the z direction and extend along the optical waveguide 10. In the present embodiment, the first ridge is used as the first optical waveguide 11, and the second ridge is used as the second optical waveguide 12.

In the optical modulation element of the present invention, both the first ridge and the second ridge having a cross-sectional shape fixed portion in which the cross-sectional shapes orthogonal to the length direction (light propagation direction) are the same, at least one of the first ridge and the second ridge having a cross-sectional shape non-fixed portion in which the cross-sectional shape is different from that of the cross-sectional shape fixed portion. Here, the configuration of the first ridge and the second ridge is configured so that the light propagating through the two optical waveguides causes a phase difference at the coupling section even when the DC bias voltage is 0V. In other words, even if at least one of the first ridge and the second ridge has a cross-sectional shape non-fixed portion different from the cross-sectional shape fixed portion, if the two propagating lights does not cause a phase difference when the DC bias voltage is 0V, it does not correspond to the optical modulation element of the present invention.

In the following, when the DC bias voltage is 0 V, the light propagating through the two optical waveguides may be referred to as an asymmetric portion with respect to the cross-sectional shape non-fixed portion that causes a phase difference at the coupling section.

The optical waveguide 10 shown in FIGS. 2 and 3 has a configuration in which only the second ridge 12 has a cross-sectional shape non-fixed portion 12b as an asymmetric portion, either or both of the first ridge 11 and the second ridge 12 may have a cross-sectional shape non-fixed portion. The optical waveguide 10 has a configuration in which the second ridge 12 has a cross-sectional shape non-fixed portion 12b in addition to the cross-sectional shape fixed portion 12a, and the first ridge 11 has only the cross-sectional shape fixed portion 11a.

In the present embodiment, as a typical example, a case where only one ridge of the two ridges has a cross-sectional shape non-fixed portion in which the cross-sectional shape thereof is rectangular, and which has a width different from that of the cross-sectional shape fixed portion, and which has a height (thickness) as the same as that of the cross-sectional shape fixed portion, will be described with reference to FIGS. 2 to 5. In this case, the area (cross-sectional area) of the cross-sectional shape differs between the cross-sectional shape fixed portion and the cross-sectional shape non-fixed portion.

In addition, both or one of the cross-sectional shape fixed portion and the cross-sectional shape non-fixed portion may have a configuration in which the width is different (variable) in the height direction (z direction) in the cross-sectional shape (for example, the cross section shape is triangular, trapezoid, etc.). Therefore, including this case as well, in the present specification, the “width” of the cross-sectional shape fixed portion and the cross-sectional shape non-fixed portion means a width at a position that is half of the maximum value in the height direction (z direction) in the cross-sectional shape and a width in the direction parallel to the main surface of the substrate Sb. Here, the cross section in the cross-sectional shape is a cross section orthogonal to the length direction (light propagation direction) of the optical waveguide, as described above.

The characteristics of the cross-sectional shape non-fixed portion of this example using the reference numerals shown in FIGS. 4 and 5 are explained. Regarding the width, the width W2 of the cross-sectional shape non-fixed portion 12b of the second ridge 12 is different from the width W20 of the cross-sectional shape fixed portion 12a of the second ridge 12 and the width W10 of the entire first ridge 11 (W2>W20=W10). Regarding the height (thickness), the height of the second ridge 12 (cross-sectional shape fixed portion 12a and cross-sectional shape non-fixed portion 12b (height: Ha)) is the same as that of the first ridge 11 (height: Hb).

The cross-sectional shape of the cross-sectional shape non-fixed portion 12b is not particularly limited as long as it is different from the cross-sectional shape of the cross-sectional shape fixed portion 12a. Even when the cross-sectional shapes of the cross-sectional shape non-fixed portion and the cross-sectional shape fixed portion are similar to each other, the cross-sectional shapes are different from each other as long as the above phase difference occurs.

Further, the length L of the cross-sectional shape non-fixed portion 12b is not particularly limited and can be appropriately determined according to a desired phase difference.

By providing the cross-sectional shape non-fixed portion as an asymmetric portion, a difference in group velocity occurs between the first optical waveguide and the second optical waveguide, thereby causing a phase difference. From this point of view, the cross-sectional shape of the ridge of the cross-sectional shape non-fixed portion is not particularly limited, and examples thereof include a rectangle, a trapezoid, a triangle, and a semicircle. Further, the size (L or W2 in FIG. 3) and the number of the cross-sectional shape non-fixed portion are not particularly limited, and may be singular or plural. When a plurality of the cross-sectional shape non-fixed portion are provided, their shapes, sizes, and the like may or may not be the same. Further, the cross-sectional shape non-fixed portion may be provided only in one optical waveguide or may be provided in both optical waveguides. Further, a taper may be provided at the end of the cross-sectional shape non-fixed portion in the length direction.

By providing the cross-sectional shape non-fixed portion, as a result, the optical output at the DC bias voltage of 0 V can be made smaller than the maximum value, so that the DC bias voltage for controlling the operating point can be reduced. The cross-sectional shape, size of the ridge of the cross-sectional shape non-fixed portion, and the number of the cross-sectional shape non-fixed portion may be set according to the shift amount of the required operating point.

The ross-sectional shape of the cross-sectional shape fixed portion of the first ridge 11 and the second ridge 12 may be any shape as long as it can guide light, and may be, for example, a rectangle, a trapezoid, a triangle, a semicircle, or the like. The width of the two ridges in the y direction is preferably 0.3 μm or more and 5.0 μm or less, and the heights of the two ridges (protruding heights Ha and Hb from the first surface 40a) are, for example, preferably 0.1 μm or more and 1.0 μm or less. The ridges are made of the same material as the lithium niobate film 40.

Although the position of the cross-sectional shape non-fixed portion on the optical wave guide is not limited, from the viewpoint of more accurately applying an electric field to the first optical waveguide 11 and the second optical waveguide 12, the cross-sectional shape non-fixed portion is preferably formed at a position where it does not overlap with the first electrode 25 and the second electrode 26 when viewed in a plan view from the z direction.

The lithium niobate film 40 is, for example, a c-axis oriented lithium niobate film. The lithium niobate film 40 is, for example, an epitaxial film epitaxially grown on the substrate Sb. The epitaxial film is a single crystal film whose crystal orientations are aligned by the underlying substrate. The epitaxial film is a film having a single crystal orientation in the z-direction and the xy in-plane direction, and the crystals are aligned in the x-axis, y-axis, and z-axis directions. Whether or not the film formed on the substrate Sb is an epitaxial film can be proved, for example, by confirming the peak intensity at the orientation position in 2θ-θ X-ray diffraction and poles. The lithium niobate film 40 may be a lithium niobate film provided on the Si substrate via SiO₂.

Specifically, in the 2θ-θ X-ray diffraction measurement, all the peak intensities except for the peak intensity on a target plane must be equal to or less than 10%, preferably equal to or less than 5%, of the maximum peak intensity on the target plane. For example, in a c-axis oriented epitaxial lithium niobate film, the peak intensities except for the peak intensity on a (00L) plane are equal to or less than 10%, preferably equal to or less than 5%, of the maximum peak intensity on the (00L) plane. (00L) is a general term for (001), (002) and other equivalent planes.

Further, under the condition for confirming the peak intensity at the above-mentioned orientation position, only the orientation in a single direction is proved. Therefore, even if the above conditions are satisfied, if the crystal orientations are not aligned in the plane, the intensity of the X-rays does not increase at a specific angle position, and no extreme point is observed. For example, when the lithium niobate film 40 is a lithium niobate film, since LiNbO₃ has a trigonal crystal system structure, single-crystal LiNbO₃ (014) has three poles. For the lithium niobate film, it is known that crystals rotated by 180° about the c-axis are epitaxially grown in a symmetrically coupled twin crystal state. In this case, three poles are symmetrically coupled to form six poles. When the lithium niobate film is formed on a single-crystal silicon substrate having a (100) plane, the substrate has four-fold symmetry, and 4×3=12 poles are observed. In the present invention, the lithium niobate film epitaxially grown in the twin crystal state is also considered to be an epitaxial film.

The lithium niobate film has a composition of LixNbAyOz. A denotes an element other than Li, Nb, and O, wherein x is 0.5 or more and 1.2 or less, preferably 0.9 or more and 1.05 or less. y is 0 or more and 0.5 or less. z is 1.5 or more and 4.0 or less, preferably 2.5 or more and 3.5 or less. Examples of the element A include K, Na, Rb, Cs, Be, Mg, Ca, Sr, Ba, Ti, Zr, Hf, V, Cr, Mo, W, Fe, Co, Ni, Zn, Sc, Ce, and the like, or may be a combination of two or more of them.

The film thickness of the lithium niobate film 40 is, for example, 2 μm or less. The film thickness of the lithium niobate film 40 is the film thickness of the portion other than the ridge. If the thickness of the lithium niobate film 40 is large, the crystallinity may decrease.

The film thickness of the lithium niobate film 40 is, for example, about 1/10 or more of the wavelength of the light used. When the film thickness of the lithium niobate film 40 is thin, the light is weakly confined and the light leaks to the substrate Sb and the buffer layer 30. If the thickness of the lithium niobate film 40 is thick, even if an electric field is applied to the lithium niobate film 40, the change in the effective refractive index of the optical waveguide 10 may be small.

The electrodes 21 and 22 are electrodes that apply a modulation voltage Vm to the optical waveguide 10. The electrode 21 is an example of the first electrode, and the electrode 22 is an example of the second electrode. The first end 21a of the electrode 21 is connected to the power supply 31, and the second end 21b is connected to the terminating resistor 32. The first end 22a of the electrode 22 is connected to the power supply 31, and the second end 22b is connected to the terminating resistor 32. The power supply 31 is a part of the drive circuit 110 that applies the modulation voltage Vm to the optical modulation element 100.

The electrodes 23 and 24 are electrodes that apply a DC bias voltage Vdc to the optical waveguide 10. The first end 23a of the electrode 23 and the first end 24a of the power supply 24 are connected to the power supply 33. The power supply 33 is a part of the DC bias application circuit 120 that applies the DC bias voltage Vdc to the optical modulation element 100.

In FIG. 2, for easy viewing, the line widths and line spacings of the electrodes 21 and 22 arranged in parallel are wider than they actually are. Therefore, the length of the portion where the electrode 21 and the first optical waveguide 11 overlap (interaction length) and the length of the portion where the electrode 22 and the second optical waveguide 12 (interaction length) overlap each other seem to be different, these lengths (interaction lengths) are approximately the same. Similarly, the length of the portion where the electrode 23 and the first optical waveguide 11 (interaction length) overlap each other and the length of the portion where the electrode 24 and the second optical waveguide 12 (interaction length) overlap each other are approximately the same.

When the DC bias voltage Vdc is superimposed on the electrodes 21 and 22, the electrodes 23 and 24 may not be provided. Further, a ground electrode may be provided around the electrodes 21, 22, 23, 24.

The electrodes 21, 22, 23, 24 are on the lithium niobate film 40 with the buffer layer 30 interposed therebetween. Electrodes 21 and 23 can each apply an electric field to the first optical waveguide 11. The electrodes 21 and 23 are, for example, located at positions where they overlap with the first optical waveguide 11 in a plan view from the z direction, respectively. The electrodes 21 and 23 are above the first optical waveguide 11, respectively. Electrodes 22 and 24 can each apply an electric field to the second optical waveguide 12. The electrodes 22 and 24 are, for example, located at positions where they overlap with the second optical waveguide 12 in a plan view from the z direction, respectively. The electrodes 22 and 24 are above the second optical waveguide 12, respectively.

The buffer layer 30 is located between the optical waveguide 10 and the electrodes 21, 22, 23, 24. The buffer layer 30 covers and protects the ridges. Further, the buffer layer 30 prevents the light propagating through the optical waveguide 10 from being absorbed by the electrodes 21, 22, 23, 24. The buffer layer 30 has a lower refractive index than the lithium niobate film 40. The buffer layer 30 is, for example, SiO₂, Al₂O₃, MgF₂, La₂O₃, ZnO, HfO₂, MgO, Y₂O₃, CaF₂, In₂O₃, or a mixture thereof.

The chip size of the optical modulation element 100 is, for example, 100 mm² or less. If the chip size of the optical modulation element 100 is 100 mm² or less, it can be used as an optical modulation element for a data center.

The optical modulation element 100 can be manufactured by a known method. The optical modulation element 100 is manufactured using semiconductor processes such as epitaxial growth, photolithography, etching, vapor phase growth and metallization.

The optical modulation element 100 converts an electric signal into an optical signal. The optical modulation element 100 modulates the input light Lᵢₙ to the output light Lₒᵤₜ. First, the modulation operation of the optical modulation element 100 will be described.

The input light Lᵢₙ input from the input path 13 branches into the first optical waveguide 11 and the second optical waveguide 12 and propagates. The phase difference between the light propagating through the first optical waveguide 11 and the light propagating through the second optical waveguide 12 is zero at the time of branching.

Next, a voltage is applied between the electrode 21 and the electrode 22. For example, differential signals which have the same absolute value and opposite signs, and are not out of phase with each other, may be applied to each of the electrode 21 and the electrode 22. The refractive indexes of the first optical waveguide 11 and the second optical waveguide 12 change depending on the electro-optic effect. For example, the refractive index of the first optical waveguide 11 changes by +Δn from the reference refractive index n, and the refractive index of the second optical waveguide 12 changes by −Δn from the reference refractive index n.

The difference in the refractive index between the first and second optical waveguides 11 and 12 creates a phase difference between the light propagating through the first optical waveguide 11 and the light propagating through the second optical waveguide 12. The light propagating through the first and second optical waveguides 11 and 12 merges at the output path 14 and is output as output light Lₒᵤₜ. The output light Lₒᵤₜ is a superposition of the light propagating through the first optical waveguide 11 and the light propagating through the second optical waveguide 12. The intensity of the output light Lₒᵤₜ changes according to an odd multiple of the phase difference between the light propagating through the first optical waveguide 11 and the light propagating through the second optical waveguide 12. For example, when the phase difference is an even multiple of π, the light strengthens each other, and when the phase difference is an odd multiple of π, the light weakens each other. In such a procedure, the optical modulation element 100 modulates the input light Lᵢₙ into the output light Lₒᵤₜ according to the electric signal.

A modulation voltage Vm corresponding to the modulation signal is applied to the electrodes 21 and 22 for applying the modulation voltage of the optical modulation element 100. The voltage applied to the electrodes 23 and 24 for applying the DC bias voltage, that is, the DC bias voltage Vdc output from the DC bias application circuit 120 is controlled by the DC bias control circuit 130. The DC bias control circuit 130 adjusts the operating point Vd of the optical modulation element 100 by controlling the DC bias voltage Vdc. The operating point Vd is a voltage that is the center of the modulation voltage amplitude.

The optical modulation curve by the optical modulation element 100 will be described with reference to FIG. 6. FIG. 6 shows the relationship between the DC bias voltage and the output both in the optical modulator 200 according to the first embodiment and in a conventional optical modulator in which the length and shape of and the two branched optical waveguides are unified, that is, there is no cross-sectional shape non-fixed portion in which the optical waveguide causes a phase difference. The horizontal axis of FIG. 6 is the DC bias voltage applied to the electrodes 23 and 24, and the vertical axis is the standardized output from the optical modulation element 100. The output is standardized as “1” when the phase difference between the light propagating through the first optical waveguide 11 and the light propagating through the second optical waveguide 12 is zero. The solid line shows the characteristics of the optical modulator of the conventional configuration, and the broken line shows the characteristics of the optical modulator of the first embodiment.

When the first ridge and the second ridge do not have a cross-sectional shape non-fixed portion and have the same length, there is no phase difference between the light propagating through the first optical waveguide 11 and the light propagating through the second optical waveguide 12. Therefore, at least in a state where no voltage is applied (Vdc=0), lights having the same phase passing through the two optical waveguides interferes with each other at the optical coupling section 16 and strengthens each other, and the output as the optical modulation element 100 becomes the maximum value.

On the other hand, in a configuration in which at least one of the first ridge and the second ridge has a cross-sectional shape non-fixed portion as in the present embodiment, the group velocities of the light propagating through the first optical waveguide 11 and the light propagating through the second optical waveguide 12 becomes asymmetric, and a phase difference is generated between the lights. Therefore, even when the applied DC bias voltage is 0 V (Vdc=0), as a result of the light having different phases passing through each interfering with each other at the coupling section 16, the output as the optical modulation element 100 does not become the maximum value and becomes smaller than the maximum value. That is, the operating point Vd is shifted to the 0V side in the configuration in which at least one of the first ridge and the second ridge has the cross-sectional shape non-fixed portion, based on the configuration in which the cross-sectional shape non-fixed portion is not provided and the length is the same. The example shown in FIG. 6 is a case where the operating point Vd is shifted to the 0V side by (½) Vπ and the operating point Vd′ is approximately 0 (V).

As a result, the linear bias voltage Vdc applied to the electrodes 23 and 24 in order to control the operating point can be set to approximately 0 (V). Further, it is possible to correct the operating point by DC drift or the like in a smaller voltage range.

The output from the optical modulation element 100 gradually decreases from the maximum value as the applied voltage increases, and becomes the minimum at a certain voltage. The voltage at which the output from the optical modulation element 100 is minimized is the null point voltage Vn. The half-wavelength voltage (half-wavelength phase modulation voltage) is a voltage for making the phase difference of light 180° in the Mach Zender type optical modulator, and is a voltage width from the maximum to the minimum output from the optical modulation element 100 corresponds to the half-wavelength voltage Vπ. When a voltage exceeding the null point voltage Vn is applied, the output from the optical modulation element 100 changes periodically. The output from the optical modulation element 100 repeats maximum and minimum for each half-wavelength voltage Vπ.

As a result, in the optical modulation element 100 of the present embodiment, whether or not the optical output is smaller than the maximum value can be judged by applying a DC bias voltage to the electrodes 23 and 24, monitoring the output from the modulation element, and comparing with the output values in the state where it is not applied (Vdc=0). Specifically, the maximum value and the minimum value are determined by gradually increasing the applied DC bias voltage and measuring the point where the optical output reverses and increases from the minimum value and the point where the optical output reverses and decreases from the maximum value. A modulation signal may be applied to the electrodes 21 and 22. By plotting the maximum and minimum values of the optical output at each DC bias voltage, the maximum and minimum values of the intensity of the optical output can be determined.

In the configuration of FIG. 2, there are two Vπs, a half-wavelength voltage Vπ (RF) at the electrodes 21 and 22 to which the modulation voltage Vm is applied, and a Vπ (DC) at the electrodes 23 and 24 to which the DC bias voltage is applied. In order to measure the maximum value and the minimum value, the electrodes 23 and 24 may be applied in a range of 2×Vπ (DC). The maximum value in this range is defined as the maximum value, and the minimum value in this range is defined as the minimum value. When the DC bias voltage Vdc is superimposed on the electrodes 21 and 22, the electrodes 23 and 24 need not be provided, and Vπ (RF) and Vπ (DC) have the same value.

The half-wavelength voltage Vπ of the optical modulation element 100 changes depending on the configuration of the optical modulation element 100. The half-wavelength voltage Vπ varies depending on, for example, the lengths of the electrodes 21 and 23 on the first optical waveguide 11, the lengths of the electrodes 22 and 24 on the second optical waveguide 12, and the like. In the case of FIG. 2, it is the length of the portion of the electrodes 21 and 23 that overlaps with the first optical waveguide 11 or the length of the portion of the electrodes 22 and 24 that overlaps with the second optical waveguide 12. This length is called the interaction length. When the interaction length is long, the half-wavelength voltage Vπ becomes small, and when the interaction length is short, the half-wavelength voltage Vπ becomes large. When the size of the optical modulation element 100 is reduced, the interaction length is shortened and the half-wavelength voltage Vπ is increased. However, by shifting the operating point voltage Vdc to the 0V side as in the present embodiment, the DC bias voltage applied to the electrodes 23 and 24 can be suppressed to a low level.

The DC bias application circuit 120 controls the operating point voltage Vd of the optical modulation element 100. The operating point voltage Vd is the midpoint between the minimum value (Vmin) and the maximum value (Vmax) of the applied voltage. The difference between the minimum value (Vmin) and the maximum value (Vmax) of the applied voltage is the applied voltage width Vpp.

The operating point voltage Vd may fluctuate depending on the temperature of the operating environment and the like. If the operating point voltage Vd fluctuates during use, it is corrected by the DC bias control circuit 130. The DC bias control circuit 130 corrects fluctuations in the operating point voltage Vd based on, for example, the branched light Lb branched from the output light Lₒᵤₜ.

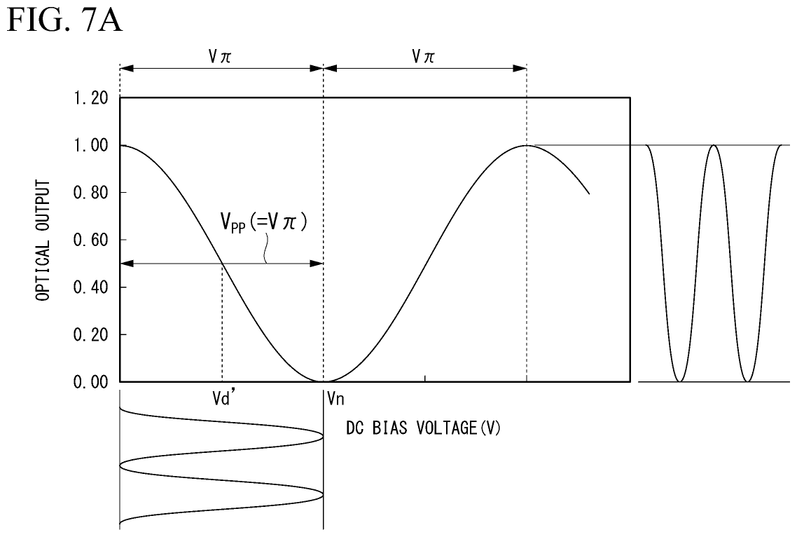

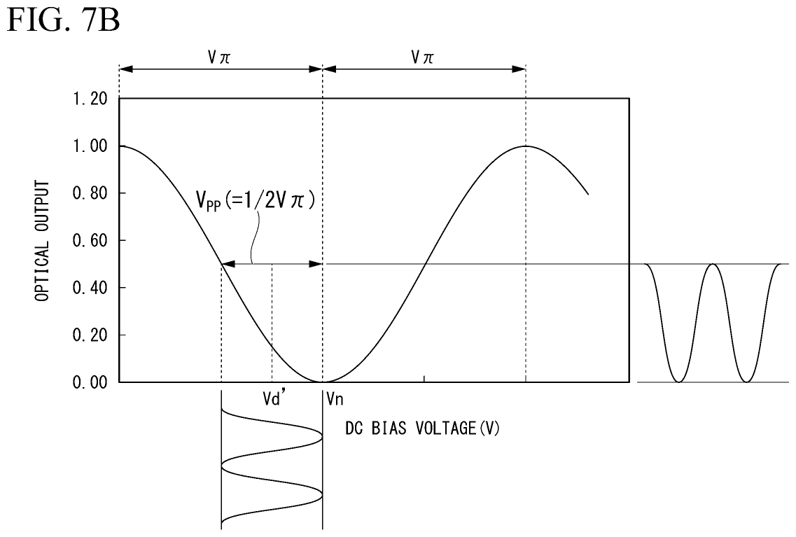

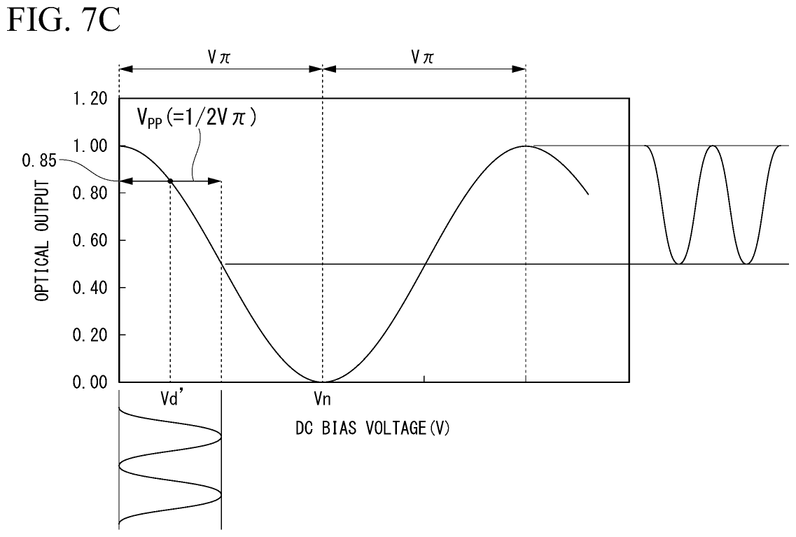

The optical modulation in the case of the optical modulation element 100 showing the modulation curve shown in FIG. 6 will be described with reference to FIG. 7A. The horizontal axis of FIG. 7A is the DC bias voltage applied to the optical modulation element 100, and the vertical axis is the intensity of the optical output at the applied voltage.

In this case, if the operating point Vd′ is set so that the shift amount of the operating point voltage is (Vn−0.5Vπ), the DC bias voltage can be set to approximately 0 (V). For example, assuming that the applied voltage width Vpp of the modulation voltage Vm is a half-wavelength voltage Vπ (RF), the modulation voltage Vm in a range of (−½) Vπ (RF) to (½) Vπ (RF) is applied to the optical modulation element 100. As shown in FIG. 7A, the optical output from the optical modulation element 100 is maximum when the modulation voltage Vm is (−½) Vπ (RF), and the optical output from the optical modulation element 100 is minimum when the modulation voltage Vm is (½) Vπ (RF), and the optical output when the modulation voltage Vm is 0V is 50% of the maximum output.

Similarly, using FIG. 7B, the optical modulation of the optical modulation element 100, in which the operating point Vd′ is controlled to be set so that the shift amount of the operating point voltage is (Vn−0.25Vπ), and the applied voltage width Vpp of the modulation voltage Vm is controlled to be set to the (¼) wavelength voltage (½) Vπ (RF), will be described.

In this case, if the operating point voltage shift amount is set to (Vn-0.25Vπ), the operating point Vd′ can be set to a DC bias voltage of approximately 0 (V). A modulation voltage Vm corresponding to the range from (−¼) Vπ (RF) to (¼) Vπ (RF) is applied to the optical modulation element 100. As shown in FIG. 7B, the optical output from the optical modulation element 100 is maximum when the modulation voltage Vm is (−¼) Vπ (RF), and the optical output from the optical modulation element 100 is minimum when the modulation voltage Vm is (¼) Vπ (RF), and the optical output when the modulation voltage Vm is 0V (Vd′) is 15% of the maximum output.

Similarly, using FIG. 7C, the optical modulation of the optical modulation element 100, in which the operating point Vd′ is controlled to be set so that the shift amount of the operating point voltage is (Vn−0.75Vπ), and the applied voltage width Vpp of the modulation voltage Vm is controlled to be set to the (¼) wavelength voltage (½) Vπ (RF), will be described.

In this case, if the operating point voltage shift amount is set to (Vn−0.75Vπ), the operating point Vd′ can be set to a DC bias voltage of approximately 0 (V). A modulation voltage Vm corresponding to the range from (−¼) Vπ (RF) to (¼) Vπ (RF) is applied to the optical modulation element 100. As shown in FIG. 7C, the optical output from the optical modulation element 100 is maximum when the modulation voltage Vm is (−¼) Vπ (RF), and the optical output from the optical modulation element 100 is minimum when the modulation voltage Vm is (¼) Vπ (RF), and the optical output when the modulation voltage Vm is 0V (Vd′) is 85% of the maximum output.

The high frequency voltage modulation signal is controlled by, for example, the drive circuit 110. The band of the modulation element is 60 GHz or more. If the frequency band of the modulation element is 60 GHz or more, it is easy to support high-speed modulation.

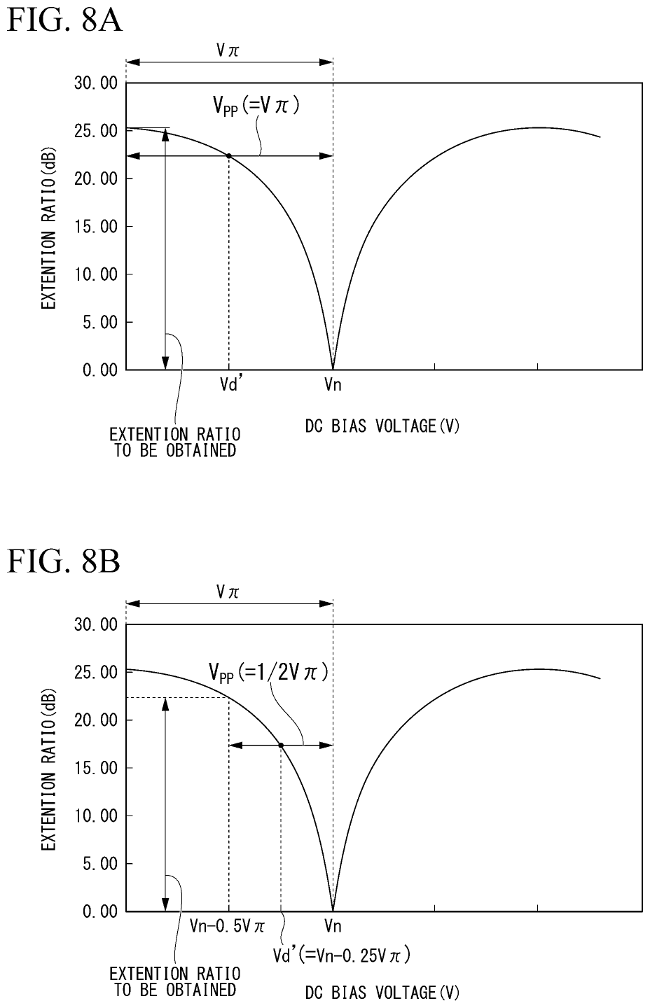

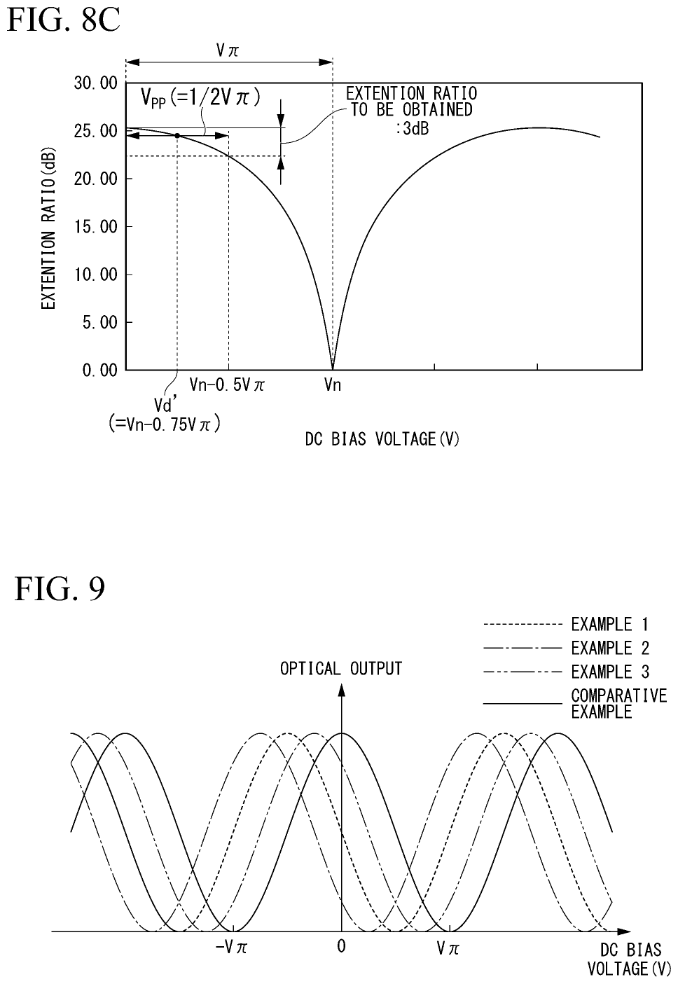

FIG. 8 is a diagram showing the relationship between the applied voltage of the light modulator 200 and the extinction ratio according to the present embodiment. The horizontal axis of FIG. 8 is the DC bias voltage applied to the optical modulation element 100, and the vertical axis is the ratio of the output light Lₒᵤₜ at the applied voltage to the output light Lₒᵤₜ at the null point voltage Vn. The extinction ratio is the ratio of the maximum value and the minimum value of the output light Lₒᵤₜ in the applied voltage range.

The extinction ratios of the optical modulation elements 100 shown in FIGS. 7A to 7C will be described with reference to FIGS. 8A to 8C.

As shown in FIG. 8A, the optical modulation element 100 of FIG. 7A shows the maximum extinction ratio (about 25 dB) in FIGS. 7A to 7C.

On the other hand, the optical modulation element 100 of FIG. 7C shows the minimum extinction ratio (about 3 dB) in FIGS. 7A to 7C as shown in FIG. 8C.

Further, in the optical modulation element 100 of FIG. 7B, as shown in FIG. 8B, the extinction ratio (about 22 dB) between them is shown in FIGS. 7A to 7C.

As shown in FIG. 8C, the extinction ratio is small in the region where the amount of light of the output light Lₒᵤₜ of the optical modulation element 100 is sufficiently large. In this way, under the condition that the applied voltage width Vpp is the same, when the operating point Vd is set at a position away from the null point voltage Vn, the amount of light is larger than when the operating point Vd is set near the null point voltage Vn, but the extinction ratio becomes smaller. However, the extinction ratio required for an optical modulator for a data center is smaller than that for an optical modulator for long-distance communication, and is about 3 dB. Therefore, by setting the operating point Vd to 85% or less of the maximum light output, the extinction ratio can be set to 3 dB or more even when Vpp is smaller than Va.

Here, the case where Vd is smaller than Vn is illustrated, but the case where it is larger than Vn may be used. In that case, the operating point can be shifted by appropriately changing the shape, length (L), and width (W2) of the asymmetric portion in the present invention.

As described above, the optical modulation element 100 and the optical modulator 200 according to the first embodiment can be driven at a low voltage and can be used in a high frequency band.

As described above, the optical modulation element 100 according to the present embodiment constitutes a Mach-Zehnder type optical waveguide, and has a first optical waveguide 11 and a second optical waveguide 12 connecting the branching section 15 and the coupling section 16. The cross-sectional shapes of the two optical waveguides are different. As a result, the group velocity of light traveling in the two optical waveguides becomes asymmetric, and a phase difference is generated between the two lights.

This phase difference exists even when an electric field is not applied to the two optical waveguides, and the lights having different phases interfere with each other at the coupling section 16 and are partially canceled out, so that the output of the light becomes a value smaller than the maximum value. As a result, the operating point voltage can be shifted to the 0V side. By adjusting the shift amount in the wavelength range of the light to be used so that the operating point voltage becomes small, it is possible to suppress an increase in the applied voltage.

The optical modulation element 100 of the present embodiment does not require adjustment of the length of each optical waveguide in order to generate a phase difference between the first optical waveguide 11 and the second optical waveguide 12. Therefore, it is possible to avoid the problem that the shape of the optical waveguide becomes complicated and its manufacturing becomes difficult.

### EXAMPLES

Hereinafter, examples of the present disclosure will be illustrated, but the present disclosure is not limited to the following examples. It is clear that a person skilled in the art can come up with various modified examples within the scope of the ideas described in the claims, and of course, these are also the technical scope of the present disclosure.

### Comparative Examples

The structures of FIGS. 2 and 4 (structures not having a cross-sectional shape non-fixed portion) were actually prototyped by the following procedure. The material of the substrate was sapphire. A lithium niobate film having a film thickness of 1.5 μm was formed on the surface of the substrate by a sputtering method. Next, the ridge was formed by Ar plasma dry etching using a resist mask. The cross-sectional shape of the ridge was rectangular, the ridge widths W10 and W20 were 1.0 μm, and the ridge height was 0.4 μm. Next, a buffer layer having a film thickness of 0.8 μm and a material LaAlO₃ was formed by a thin-film deposition method. Then, flattening by CMP was performed. Finally, the first electrode and the second electrode were formed by a photolithography step and a gold plating step.

The interaction lengths of the electrodes 21 and 22 were 8.5 mm, and the interaction lengths of the electrodes 23 and 24 were 5.0 mm. The modulation characteristics were evaluated using light having a wavelength of 1310 nm. At that time, Vπ (RF) was 8.3 (V), Vπ (DC) was 14.1 (V), and the maximum extinction ratio was 25 dB. In addition, the optical output when a DC bias voltage was applied to the electrodes 23 and 24 was measured. The results are shown in the graph of FIG. 9. A modulation signal may be applied to the electrodes 21 and 22. By plotting the maximum and minimum values of the optical output at each DC bias voltage, the maximum and minimum values of the intensity of the optical output can be determined.

### Examples

As shown in FIG. 5, it is assumed that a part of the second ridge has a cross-sectional shape non-fixed portion, and the other portions are exactly the same as in the comparative example. In Example 1 shown in FIG. 6, the cross-sectional shape of the cross-sectional shape non-fixed portion of the second ridge is rectangular, and the shape in the plan view from the z direction is also rectangular, and the length L in the x direction was 0.53 mm. The width W2 in the y direction was 1.15 μm. In Example 1, it can be seen that the optical output intensity is 50% of the maximum value in the state where the DC bias voltage is not applied, and the operating point voltage is shifted by (½) Vπ.

In Example 2, the cross-sectional shape of the cross-sectional shape non-fixed portion of the second ridge is rectangular, and the shape in the plan view from the z direction is also rectangular. The length L in the x direction was set to 0.63 mm, and the width W2 in the y direction was set to 1.15 μm. In Example 3, the cross-sectional shape of the cross-sectional shape non-fixed portion of the second ridge is also rectangular, and the shape in the plan view from the z direction is also rectangular. The length L in the x direction was set to 48 mm, and the width W2 in the y direction was set to 1.15 μm. The calculation results of the light output characteristics obtained in Examples 2 and 3 are shown in the graph of FIG. 9. The horizontal axis of the graph shows the DC bias voltage (V), and the vertical axis of the graph shows the optical output intensity. The solid line corresponds to the output characteristics obtained in Comparative Example, the broken line corresponds to the output characteristics obtained in Example 1, the one-dot chain line corresponds to the output characteristics obtained in Example 2, and the two-dot chain line corresponds to the output characteristics obtained in Example 3.

In the case of the Comparative Example, when the DC bias voltage is not applied, the optical output intensity is the maximum value, and no shift in the operating point voltage is observed. On the other hand, in Example 2, the optical output intensity is 15% of the maximum value in the state where the DC bias voltage is not applied, and the operating point voltage is shifted by (¾) Vπ. Further, in Example 3, the optical output intensity is 85% of the maximum value in the state where the DC bias voltage is not applied, and the operating point voltage is shifted by (¼) Vπ.

In the case of Example 3 in which the optical output intensity is 85% of the maximum value, an extinction ratio of 3 dB can be obtained by setting the DC bias voltage 0 (V) as the operating point and the applied voltage width Vpp as (½) Vπ (modulation voltage Vm in the range of −(¼) Vπ to +(¼) Vπ). The shift amount of the operating point voltage can be arbitrarily designed according to the required drive conditions of the optical modulator. When a large extinction ratio is desired to be obtained with a small applied voltage width Vpp, it is preferable to set the shift amount of the operating point voltage so that the optical output intensity is in the range of 0% to 50% of the maximum value when the DC bias voltage is not applied.

The shift amount of the operating point voltage can be changed by adjusting the size, shape, and the like of the cross-sectional shape non-fixed portion. In Examples 1 to 3, the shift amount of the operating point voltage was changed by changing the length L thereof in the x direction in FIG. 3. The shift amount of the operating point voltage may be changed by changing the width W2 thereof in the y direction, or by changing both the length L and the width W2 thereof. Further, the cross-sectional shape orthogonal to the length direction of the cross-sectional shape non-fixed portion may be adjusted.

According to the present invention, it is possible to realize an optical modulation element that can be easily manufactured while suppressing the DC bias voltage to a low level even when the element size is small.

What is claimed is:

1. An optical modulation element, comprising:
a substrate made of a material different from lithium niobate;
a lithium niobate film formed on a main surface of the substrate, the lithium niobate film including a Mach-Zehnder-type optical waveguide having a first ridge and a second ridge that function as a first optical waveguide and a second optical waveguide connected a branching section and a coupling section, respectively;
a first electrode that applies an electric field to the first optical waveguide; and
a second electrode that applies an electric field to the second optical waveguide,
wherein both the first ridge and the second ridge having a cross-sectional shape fixed portion in which the cross-sectional shapes orthogonal to the length direction are the same, at least one of the first ridge and the second ridge having a cross-sectional shape non-fixed portion in which the cross-sectional shape is different from that of the cross-sectional shape fixed portion, and
the optical output obtained when the DC bias voltage applied between the first electrode and the second electrode is 0 (V) is smaller than the maximum of the optical output obtained when the DC bias voltage is changed in a predetermined voltage range.

2. The optical modulation element according to claim 1, wherein the width of the cross-sectional shape non-fixed portion is different from that of the cross-sectional shape non-fixed portion.

3. The optical modulation element according to claim 1, wherein the cross-sectional area of the cross-sectional shape non-fixed portion is different from that of the cross-sectional shape non-fixed portion.

4. The optical modulation element according to claim 1, wherein the cross-sectional shape non-fixed portion is arranged in a region that does not overlap with either the first electrode or the second electrode.

5. The optical modulation element according to claim 1, wherein the optical output obtained when the DC bias voltage is 0 (V) is 85% or less of the difference between the maximum and minimum values of the optical output obtained when the DC bias voltage is changed in a predetermined voltage range.

6. An optical modulator comprising an optical modulation element according to claim 1.
